(19) United States
(12) Patent Application Publication
(10) Pub. No.: US 2014/0189370 A1
(43) Pub. Date: Jul. 3, 2014

(54) MEMORY DEVICES, AND SYSTEMS AND METHODS FOR VERIFYING SECURE DATA STORAGE

(71) Applicant: Samsung Electronics Co., Ltd., Suwon-Si (KR)

(72) Inventors: Hyoung-Suk JANG, Suwon-si (KR); Kwang-il PARK, Yongin-si (KR); Hee-Chang CHO, Seoul (KR)

(73) Assignee: Samsung Electronics Co., Ltd., Suwon-Si (KR)

(21) Appl. No.: 14/143,574

(22) Filed: Dec. 30, 2013

(30) Foreign Application Priority Data
Jan. 2, 2013 (KR) 10-2013-0000268

(51) Int. Cl. G06F 21/60

(52) U.S. Cl. CPC G06F 21/60
USPC 713/193; 726/26

(57) ABSTRACT

A memory device includes an input/output (I/O) interface, a secure logic for receiving a storage verifying command including an expected value of secure data via the I/O interface, an I/O logic for receiving an input request for inputting user data into the memory device and/or an output request for outputting user data therefrom and perform one of the input request and/or the output request, and a memory unit including a secure area, accessible by the secure logic, for storing the secure data and a normal area, accessible by the I/O logic, for storing the user data. The secure logic reads the secure data from the secure area in response to the input of the storage verifying command and outputs a storage verifying result to the external device, without outputting the secure data to the external device, according to whether the secure data expected value is identical with the secure data.

### CROSS-REFERENCE TO RELATED APPLICATION

This application claims priority from Korean Patent Application No. 10-2013-0000268 filed on Jan. 2, 2013 in the Korean Intellectual Property Office, and all the benefits accruing therefrom under 35 U.S.C. 119, the contents of which, in their entirety, are herein incorporated by reference.

### BACKGROUND

1. Field of the Invention

The present disclosure relates to memory devices, systems and methods for verifying whether secure data is properly stored. More particularly, the present disclosure relates to memory devices, systems and methods for verifying whether secure data stored in a read inaccessible area is properly stored.

2. Description of the Related Art

An electrostatic discharge (ESD) phenomenon is one factor causing a failure in a circuit. The ESD is one type of static electricity and due to the trends toward miniaturization and high integration of electronic or electric devices, the ESD phenomenon has become a susceptible issue. In particular, since an electronic or electric device employing a touch-type display, such as a TV, a smart phone or a tablet PC, applies a user's haptic input, the ESD phenomenon may often occur due to user's touch.

In a case where the secure data is programmed in a read-inaccessible area of a memory device, in order to prevent leakage of secure data, it is not possible to verify whether the programming of the secure data is properly performed by a read-back-after-program method. If the secure data is used for authentication of the memory device, the authentication of the memory device may fail due to erroneous programming of secure data in the memory device.

Therefore, the memory device for programming the secure data in the read-inaccessible area needs to have a function of verifying whether the stored secure data is properly stored or not.

### SUMMARY

Some example embodiments provide memory devices, systems and methods, which may program secure data in a read inaccessible area and has a function of verifying whether the stored secure data is properly stored.

In one example embodiment, a memory device includes an input/output (I/O) interface, a secure logic configured to receive a storage verifying command including an expected value of secure data, from an external device via the I/O interface. The memory device further includes an I/O logic configured to receive a request for at least one of inputting user data into the memory device and outputting user data from the memory device, via the I/O interface and perform at least one of the inputting and the outputting based on the request. The memory device further includes a memory unit including a secure area for storing the secure data, the secure area being accessible by the secure logic, and a normal area storing the user data, the normal area being accessible by the I/O logic. The secure logic is configured to read the secure data from the secure area in response to the input of the storage verifying command and output a storage verifying result to the external device, without outputting the secure data to the external device, according to whether the secure data expected value is identical to the secure data.

In yet another example embodiment, the secure area is a read only accessible area.

In yet another example embodiment, the secure data is an intrinsic identifier of the memory device.

In one example embodiment, a system for verifying secure data storage includes, a secure verifying unit configured to receive a verify request signal including an expected value of secure data, an I/O interface and a secure logic configured to respond to a storage verifying command from the secure verifying unit received via the I/O interface. The system further includes an I/O logic configured to receive a request for at least one of inputting user data into a memory device and outputting user data from the memory device via the I/O interface and perform at least one of the inputting and the outputting based on the request. The system further includes a memory unit including a secure area storing the secure data, the secure area being accessible by the secure logic, and a normal area storing the user data, the normal area being accessible by the I/O logic. The secure logic is configured to read the secure data from the secure area in response to the input of the storage verifying command, convert the secure data, and output the converted secure data to the secure verifying unit. The secure verifying unit is configured to receive the converted secure data from the secure logic, determine whether the secure data expected value is equal to the secure data using the converted secure data, and output a storage verification result according to whether the secure data expected value is equal to the secure data.

In yet another example embodiment, the secure logic, the I/O logic, the I/O interface and the memory unit are provided in a memory device, and the secure verifying unit is provided in a storage verifying system connected to the memory device via the I/O interface.

In yet another example embodiment, the secure logic, the I/O logic, the I/O interface and the memory unit are provided in a memory device and the secure verifying unit is provided in a controller connected to the memory device.

In yet another example embodiment, the secure logic is configured to encrypt the secure data using a verifying key and output the encrypted secure data to the secure verifying unit and the secure verifying unit is configured to decrypt the encrypted secure data received from the secure logic using the verifying key, extract the secure data and determine whether the extracted secure data is equal to the expected value.

In yet another example embodiment, the secure verifying unit deletes the extracted secure data after determining whether the extracted secure data is equal to the expected value.

In yet another example embodiment, the verifying key is stored in the secure logic and the secure verifying unit.

In yet another example embodiment, the normal area includes a system area that is read only accessible, a user area that is read/write accessible and the encrypted secure data is stored in the system area.

In yet another example embodiment, an encryption key used for encrypting the secure data stored in the system area is different from the verifying encryption key.

In yet another example embodiment, the secure logic is configured to input the secure data to a one-way function and output an output value of the one-way function to the secure verifying unit and the secure verifying unit is configured to determine whether the output value of the one-way function received from the secure logic and the output value obtained by inputting the expected value to the one-way function are equal.

In yet another example embodiment, the secure verifying unit deletes the output value of the one-way function received from the secure logic upon determining whether the output value of the one-way function received from the secure logic and the output value obtained by inputting the expected value to the one-way function are equal.

In one example embodiment, a system includes a memory device. The memory device includes memory unit having at least a secure area for storing secure data and secure logic configured to encrypt the secure data and output the encrypted secure data in response to a verification command. The system further includes a verifying unit configured to send the verification command to the secure logic, and determine whether secure data has been properly stored in the secure area based on the encrypted secure data output from the memory device.

In yet another example embodiment, the verifying unit is configured to send the verification command to the secure logic upon receiving a verification request from an external device.

In yet another example embodiment, the verification request includes an expected value of the secure data and the verifying unit is configured to determine whether the secure data has been properly stored in the secure area based on the encrypted secure data and the expected value.

In yet another example embodiment, the verifying unit is configured to determine whether the secure data has been properly stored in the secure area by decrypting the encrypted secure data using a verifying key, extracting the secure data and determining whether the extracted secure data corresponds to the expected value.

In yet another example embodiment, the verifying unit is further configured to output at least one of a FAIL signal and a Pass signal based on the result of the determining.

In yet another example embodiment, the secure area is only accessible by the secure logic.

### BRIEF DESCRIPTION OF THE DRAWINGS

The above and other features and advantages of the present disclosure will become more apparent by describing in detail example embodiments thereof with reference to the attached drawings in which:

FIGS. 1 to 3 are block diagrams of a memory device, according to example embodiments;

FIG. 4 is a detailed block diagram illustrating functions of a secure logic of a memory device, according to an example embodiment;

FIG. 5 is a flowchart illustrating operations of a memory device, according to an example embodiment;

FIG. 6 is a diagram illustrating an operation a memory device associated with a host, according to an example embodiment;

FIG. 7 is a block diagram of a system for verifying secure data storage, according to an example embodiment;

FIGS. 8 and 9 illustrate systems for verifying secure data storage, according to example embodiments;

FIGS. 10 and 11 are detailed block diagrams for explaining operations of a secure logic and a secure verifying unit of systems for verifying secure data storage, according to example embodiments; and

FIGS. 12 and 13 are flowcharts for explaining methods for verifying secure data storage, according to example embodiments.

### DETAILED DESCRIPTION OF THE EXAMPLE EMBODIMENTS

Various embodiments will now be described more fully with reference to the accompanying drawings. Like elements on the drawings are labeled by like reference numerals.

Detailed illustrative embodiments are disclosed herein. However, specific structural and functional details disclosed herein are merely representative for purposes of describing example embodiments. This invention may, however, be embodied in many alternate forms and should not be construed as limited to only the embodiments set forth herein.

Accordingly, while example embodiments are capable of various modifications and alternative forms, the embodiments are shown by way of example in the drawings and will be described herein in detail. It should be understood, however, that there is no intent to limit example embodiments to the particular forms disclosed. On the contrary, example embodiments are to cover all modifications, equivalents, and alternatives falling within the scope of this disclosure. Like numbers refer to like elements throughout the description of the figures.

Although the terms first, second, etc. may be used herein to describe various elements, these elements should not be limited by these terms. These terms are only used to distinguish one element from another. For example, a first element could be termed a second element, and similarly, a second element could be termed a first element, without departing from the scope of this disclosure. As used herein, the term “and/or,” includes any and all combinations of one or more of the associated listed items.

When an element is referred to as being “connected,' or “coupled,” to another element, it can be directly connected or coupled to the other element or intervening elements may be present. By contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting. As used herein, the singular forms “a”, “an”, and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Specific details are provided in the following description to provide a thorough understanding of example embodiments. However, it will be understood by one of ordinary skill in the art that example embodiments may be practiced without these specific details. For example, systems may be shown in block diagrams so as not to obscure the example embodiments in unnecessary detail. In other instances, well-known processes, structures and techniques may be shown without unnecessary detail in order to avoid obscuring example embodiments.

In the following description, illustrative embodiments will be described with reference to acts and symbolic representations of operations (e.g., in the form of flow charts, flow diagrams, data flow diagrams, structure diagrams, block diagrams, etc.) that may be implemented as program modules or functional processes include routines, programs, objects, components, data structures, etc., that perform particular tasks or implement particular abstract data types and may be implemented using existing hardware at existing network elements. Such existing hardware may include one or more Central Processing Units (CPUs), digital signal processors (DSPs), application-specific-integrated-circuits, field programmable gate arrays (FPGAs), computers or the like.

Although a flow chart may describe the operations as a sequential process, many of the operations may be performed in parallel, concurrently or simultaneously. In addition, the order of the operations may be re-arranged. A process may be terminated when its operations are completed, but may also have additional steps not included in the figure. A process may correspond to a method, function, procedure, subroutine, subprogram, etc. When a process corresponds to a function, its termination may correspond to a return of the function to the calling function or the main function.

As disclosed herein, the term “storage medium” or “computer readable storage medium” may represent one or more devices for storing data, including read only memory (ROM), random access memory (RAM), magnetic RAM, core memory, magnetic disk storage mediums, optical storage mediums, flash memory devices and/or other tangible machine readable mediums for storing information. The term “computer-readable medium” may include, but is not limited to, portable or fixed storage devices, optical storage devices, and various other mediums capable of storing, containing or carrying instruction(s) and/or data.

Furthermore, example embodiments may be implemented by hardware, software, firmware, middleware, microcode, hardware description languages, or any combination thereof. When implemented in software, firmware, middleware, or microcode, the program code or code segments to perform the necessary tasks may be stored in a machine or computer readable medium such as a computer readable storage medium. When implemented in software, a processor or processors will perform the necessary tasks.

A code segment may represent a procedure, function, subprogram, program, routine, subroutine, module, software package, class, or any combination of instructions, data structures or program statements. A code segment may be coupled to another code segment or a hardware circuit by passing and/or receiving information, data, arguments, parameters or memory contents. Information, arguments, parameters, data, etc. may be passed, forwarded, or transmitted via any suitable means including memory sharing, message passing, token passing, network transmission, etc.

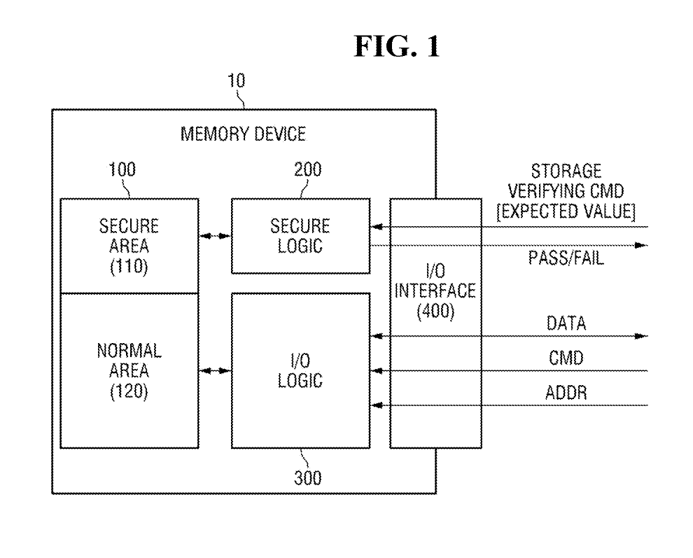

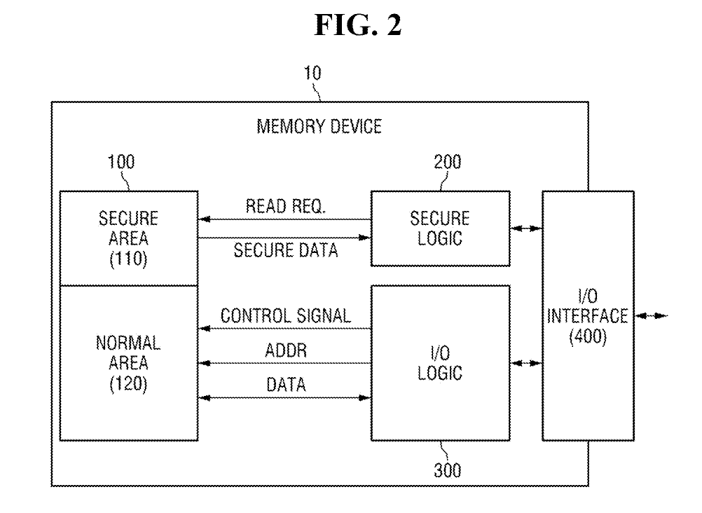

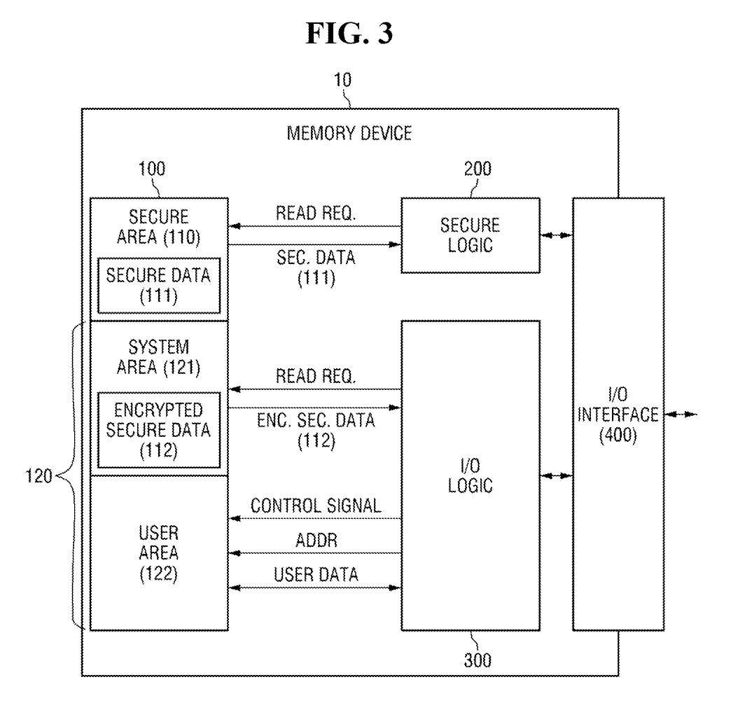

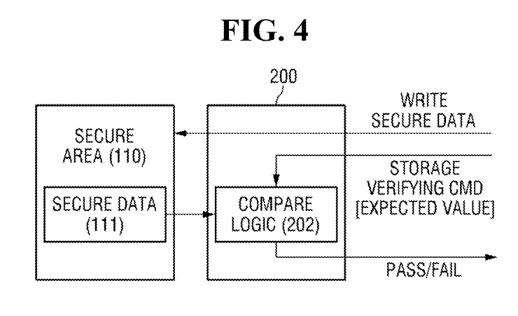

Hereinafter, a memory device according to an example embodiment will now be described with reference to FIGS. 1 to 4. FIGS. 1 and 2 are basic block diagrams of a memory device, according to an example embodiment. FIG. 3 is a block diagram of the memory device having a memory unit c including a secure area, a system area and a user area, according to an example embodiment. FIG. 4 is a detailed block diagram describing operations associated with storage verification of a secure logic provided in the memory device, according to an example embodiment.

Referring to FIG. 1, the memory device 10 may include a memory unit 100, a secure logic 200, an I/O logic 300 and an I/O interface 400.

In one example embodiment, the I/O interface 400 relays signal transmission/reception between the memory device 10 and an external device (not shown). That is to say, all signals input to or output from the memory device 10 pass through the I/O interface 400. Signals may not be input to or output from the memory device 10 without passing through the I/O interface 400.

The I/O interface 400 may be directly connected to an external device, such as a host, or may be connected to the external device through a controller (not shown) for controlling the memory unit 100.

The memory unit 100 may be a nonvolatile memory, and may be a chip or package using a NAND-flash memory, a NOR-flash memory, a phase change random access memory (PRAM), a magnetic random access memory (MRAM), a resistive random access memory (RRAM) as a storage unit. In addition, the memory device 100 according to various embodiments of the present invention may be packaged. For example, the memory device 100 may be packaged using packages such as Package on Packages (PoPs), Ball grid arrays (BGAs), Chip scale packages (CSPs), Plastic Leaded Chip Carrier (PLCC), Plastic Dual In-Line Package (PDIP), Die in Waffle Pack, Die in Wafer Form, Chip On Board (COB), Ceramic Dual In-Line Package (CERDIP), Plastic Metric Quad Flat Pack (MQFP), Thin Quad Flatpack (TQFP), Small Outline (SOIC), Shrink Small Outline Package (SSOP), Thin Small Outline (TSOP), Thin Quad Flatpack (TQFP), System In Package (SIP), Multi Chip Package (MCP), Wafer-level Fabricated Package (WFP), Wafer-Level Processed Stack Package (WSP), and the like.

The memory unit 100 may include a secure area 110 and a normal area 120. The normal area 120 is accessible by the I/O logic 300, and the secure area 110 may not be accessible by the I/O logic 300. The secure area 110 may be accessed only by the secure logic 200. Data stored in the secure area 110 may be referred to as secure data and data stored in the normal area 120 may be referred to as user data.

In one example embodiment, the secure area 110 is preferably a one-time writable area.

The secure data may be, for example, an intrinsic identifier of the memory unit 100 or an intrinsic identifier of the memory device 10, but not limited thereto. The secure data may include all data that should not be leaked out.

The I/O logic 300 may be connected to the external device (not shown) through the I/O interface 400. The I/O logic may receive a user data input or output request from the external device and performs an operation in response to the request. In one example embodiment, the I/O logic 300 may receive, for example, a read command or address information, to then output the user data stored in the address, or may receive a write command, address information and data to then store the data in the address. That is to say, the I/O logic 300 may relay input/output of the user data stored in the normal area 120. However, the I/O logic 300 may not relay input/output of the secure data stored in the secure area 110. The data stored in the secure area 110 is designed in a manner such that it may be accessed only by the secure area 110.

The secure logic 200 may be a circuit configured such that it is connected to the secure area 110 in a hardware manner to be capable of accessing the secure data stored in the secure area 110. The secure area 110 may not be included in the address system processed by the I/O logic 300 and may not be accessed by a general command. When an authentication command is applied to the secure logic 200, the secure logic 200 is driven, the data stored in the secure area 110 may be referenced for the internal operation of the secure logic 200 during authentication of the secure logic 200, and the referenced data may not be transmitted to the outside through the I/O interface 400. The secure logic 200 may be read only accessible for the secure data or may be read/write accessible for the secure data. Like the I/O logic 300, the secure logic 200 may also be directly connected to the external device through the I/O interface 400 or may be connected to the external device through the controller.

In FIG. 2, the secure logic 200 may be exemplified to be read only accessible in accessing the secure area 110. As shown in FIG. 2, the secure logic 200 may transmit a read request signal for reading the secure data stored in the secure area 110 to the memory unit 100 and may receive the secure data in response thereto. Unlike the secure logic 200, the I/O logic 300 that is read/write accessible to the normal area 120 may transmit a control signal and address information to the memory unit 100 and may transmit/receive data to/from the memory unit 100. In addition, as shown in FIG. 2, memory areas of the memory unit 100, which can be accessed by the secure logic 200 and the I/O logic 300, may be separated from each other. In other words, the memory areas accessible by the secure logic 200 and the I/O logic 300 may exist separately from each other.

As described above, the secure area 110 may be a one-time writable area. In this case, even if write access for the secure area 110 is enabled, the secure logic 200 may reject to additionally write data once data is written once.

The secure logic 200 may read the secure data by accessing the secure area 110 but may not output the secure data to the external device. That is to say, the secure logic 200 does not support a command for outputting the secure data. Instead, the secure logic 200 performs an operation requested by the external device using the secure data and outputs a result of the operation performed. For example, the secure logic 200 may receive a storage verifying command including an expected value of the secure data from a test device. As described above, the secure logic 200 may be connected to the external device to receive the storage verifying command through the I/O interface 400 or may receive the storage verifying command through the controller.

The expected value of the secure data means the secure data expected to be stored in the secure area 110. The expected value of the secure data is described as a numerical value, but not limited thereto. The expected value of the secure data may mean all types of digital data.

The secure logic 200 reads the secure data from the secure area 110 in response to the storage verifying command input from the test device, determines whether the secure data and the expected value of the secure data are equal to each other, and outputs the result of performing the storage verifying command to the test device. For example, if the secure data and the expected value of the secure data are equal to each other, the secure logic 200 outputs a PASS signal and, if not, outputs a FAIL signal, as the verification result, as shown in FIG. 1.

The memory device 10 according to an example embodiment may not output converted secure data that is reversely converted from the secure data and is vulnerable to leakage as well as the secure data. The memory device 10 according to an example embodiment inputs an expected value and outputs only a result of determination whether the expected value is actually stored or not. Therefore, the memory device 10 according to an example embodiment may minimize a leakage possibility of the secure data stored in the secure area 110.

A memory configuration of the memory device 10 according to an example embodiment will be described with reference to FIG. 3. As shown in FIG. 3, the normal area 120 may further be divided into the system area 121 and the user area 122. The system area 121 is a read only accessible by the I/O logic 300, and the user area 122 is a read/write accessible by the I/O logic 300. Encrypted data 112 of the secure data 111 stored in the secure area 110 may be stored in the system area 121.

An address may be allocated to the user area 122 to be accessed by a user application. However, while the system area 121 may be read only accessible by the I/O logic 300, an address allowing the user application to access the system area 121 is not allocated. Therefore, the system area 121 may be accessed only through a predetermined system I/O function.

The encrypted secure data 112 may be programmed together with the secure data 111 at the time of manufacturing the memory device 10.

The operation of the secure logic 200 of the memory device 10 will now be described in more detail with reference to FIG. 4.

The secure data 111 may be stored in the secure area 110. The secure data 111 may be stored in the secure area 110 through the secure logic 200, or may be directly programmed in the secure area 110 at the time of manufacturing the memory device 10. Thereafter, if a storage verifying command including an expected value is input to the secure logic 200 in order to confirm whether the storage is properly performed, the secure logic 200 reads the secure data 111 stored in the secure area 110. Then, a compare logic 202 determines whether the read secure data is equal to the expected value. According to the determination result, a PASS signal or a FAIL signal is output in response to the storage verifying command. That is to say, if the read secure data is equal to the expected value, the PASS signal is output, and if not, the FAIL signal is output.

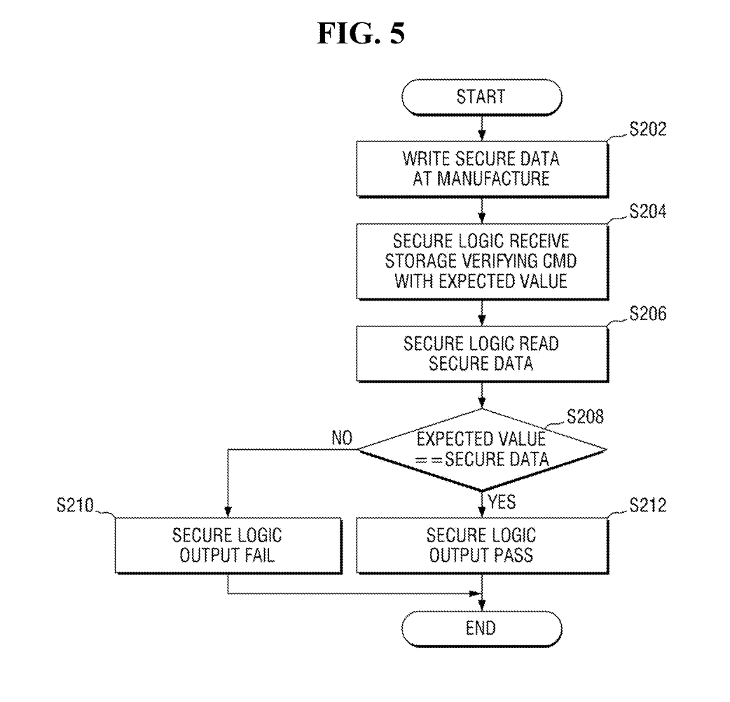

A storage verifying method of a memory device, according to an example embodiment will now be described. FIG. 5 is a flowchart illustrating operations of a memory device, according to an example embodiment.

At the time of manufacturing the memory device, secure data may be stored in the secure area 110 of the memory device 10 (S202). As described above, the secure area 110 may be accessed only by the secure logic 200 and may not be additionally programmed after it is programmed once.

Next, the secure logic 200 receives a storage verifying command (S204). The storage verifying command may include expected values expected to have been stored in the secure area 110 in forms of parameters.

The secure logic 200 reads the secure data 111 stored in the secure area 110 in response to the storage verifying command (S206). The secure logic 200 may determine whether the read secure data and the expected value are equal to each other (S208). According to the determination result, a PASS signal is output (S212) or a FAIL signal is output (S210) in response to the storage verifying command.

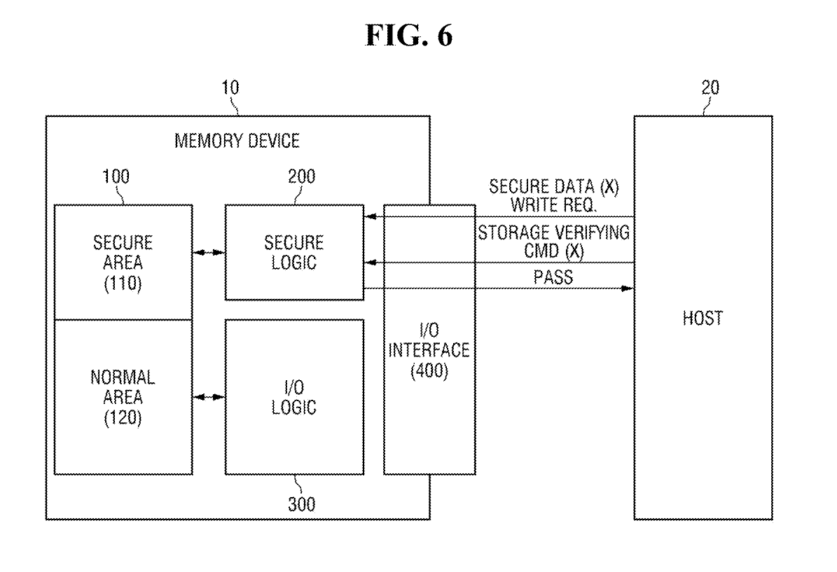

An operation of the memory device 10 associated with a host 20 will now be described according to an example embodiment will be described with reference to FIG. 6.

As shown in FIG. 6, the host 20 may make a request to program secure data X in the secure logic 200 of the memory device 10. In order to confirm whether the secure data is properly programmed as “X”, the storage verifying command and an expected value “X” are input to the secure logic 200. If the secure logic 200 performs the operation shown in FIG. 4 and the secure data is properly programmed as “X” as a value resulting from the operation performed by the secure logic 200, a response signal meaning PASS will be output to the host 20.

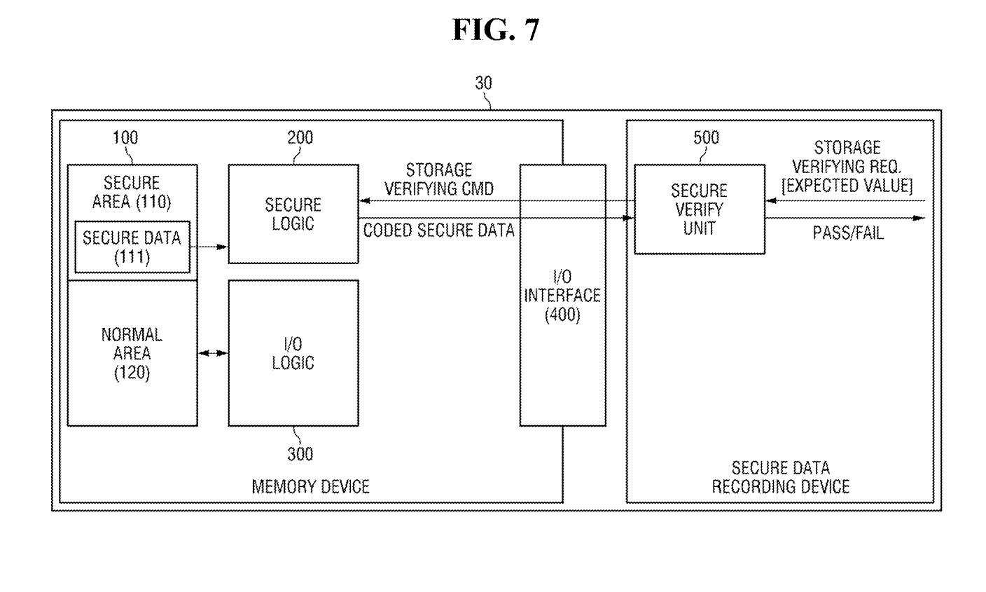

Hereinafter, a system for verifying secure data storage according to an example embodiment will be described with reference to FIGS. 7 to 11.

FIG. 7 is a block diagram of a system for verifying secure data storage according to an example embodiment.

As shown in FIG. 7, the secure data storage authentication system 30 includes a secure verifying unit 500, a secure logic 200, an I/O logic 300, an I/O interface 400 and a memory unit 100. The secure verifying unit 500 may be provided in a secure data recording device 600, and the memory unit 100, the secure logic 200, the I/O logic 300 and the I/O interface 400 may be provided in a memory device 700.

The secure data recording device may be an apparatus for inputting secure data at the time of manufacturing the memory device.

The secure verifying unit 500 receives a storage verifying request including an expected value of the secure data and performs a series of storage verifying processes. The storage verifying request is generated to confirm whether secure data is properly programmed in a secure area after the secure data is programmed at the time of manufacturing the memory device 700.

The storage verifying processes may include inputting a storage verifying command to the secure logic 200 through the I/O interface 400, receiving converted secure data from the secure logic 200 through the I/O interface 400, determining whether secure data 111 stored in the secure area 110 using the converted secure data is equal to the expected value of the secure data included in the verify request signal, and outputting the determination result.

Meanwhile, the secure logic 200 receives the storage verifying command from the secure verifying unit 500. The secure logic 200 reads the secure data 111 from the secure area 110 in response to the storage verifying command, and converts the secure data 111 in a predefined fixing method to then output the converted secure data to the secure verifying unit 500.

The converting of the secure data 111 in the “predefined way” means that the secure logic 200 may convert the secure data 111 in a particular way whenever the storage verifying command is input. For example, the secure logic 200 may encrypt the secure data 111 using a fixed encryption key and then output the encrypted secure data 111, or may input the secure data 111 to a fixed one-way function and then output the converted secure data.

The I/O logic 300 receives an input request or an output request of user data from an external device, such as a host, through the I/O interface 400 and performs a requested operation.

The memory unit 100 includes a secure area 110 that stores the secure data 111 and is accessed only by the secure logic 200, and a normal area 120 that stores the user data and is accessed through the I/O logic 300.

According to an example embodiment, the secure verifying unit 500 may receive the converted secure data from the secure logic 200 and directly determine whether the converted secure data is equal to the expected value. That is to say, if the secure verifying unit 500 is not provided, the converted data of the secure data 111 output from the secure logic 200 may not be analyzed. Therefore, having the secure verifying unit 500 may reduce a possibility of the secure data leakage.

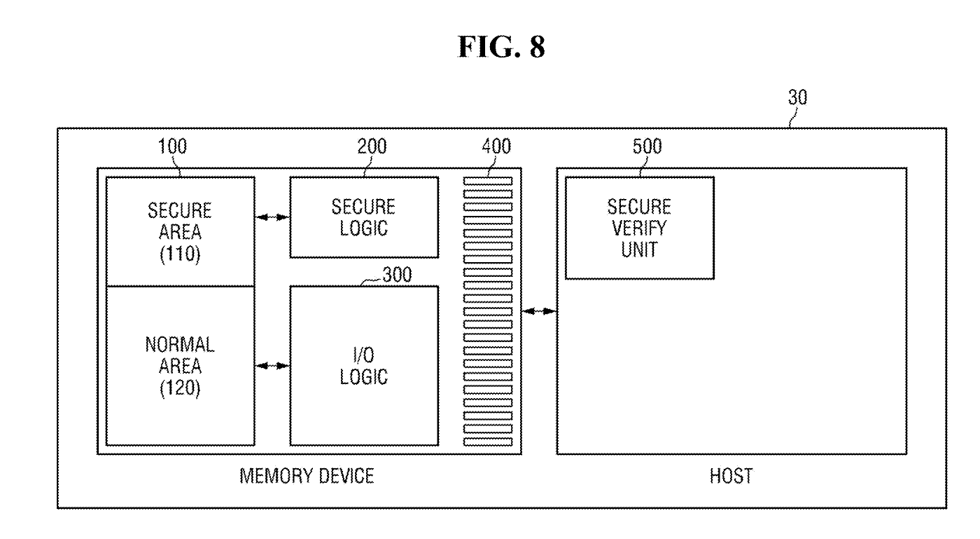

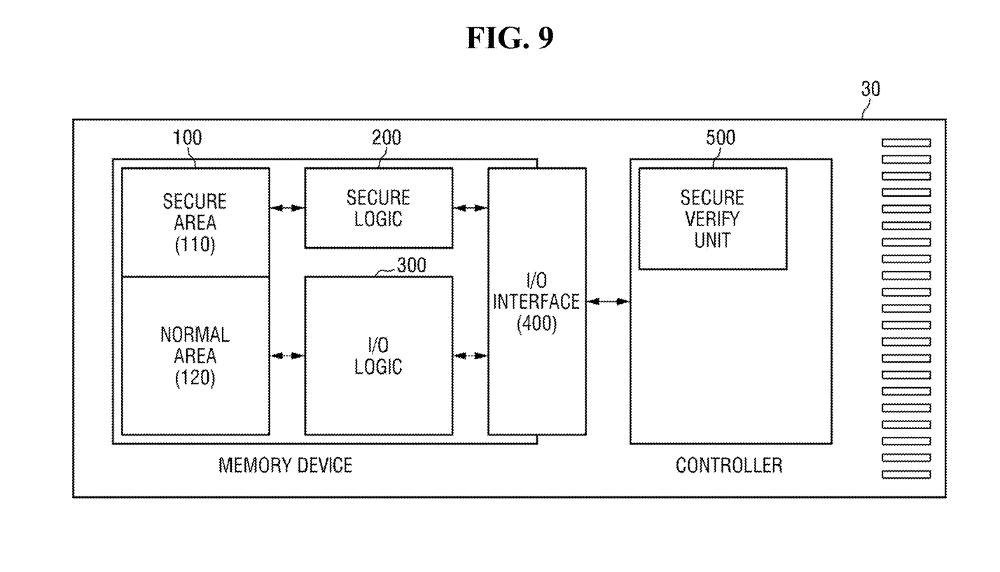

FIGS. 8 and 9 illustrate systems for verifying secure data storage according to example embodiments.

Referring to FIG. 8, the secure data storage authentication system 30 according to an example embodiment, may include a memory device 50 including a secure logic 200, an I/O logic 300, an I/O interface 400 and a memory unit 100, and a host 40 including a secure verifying unit 500. The host 40 may be connected to the memory device to then operate. The memory device 50 may be, for example, a portable memory device, such as an SD card, an MMC card, a smart card, or a USB memory. The memory device 50 may be a solid State Drive (SSD). The secure verifying unit 500 may operate in the same manner as the secure verifying unit 500 shown in FIG. 7. However, in one example embodiment, the secure verifying unit 500 shown in FIG. 8 receives the storage verifying request only from an authenticated application program. If the storage verifying request is allowed to be received from a hacking program, the hacking program may randomly generate the expected value of the secure data and may obtain the secure data 111 by repeatedly performing an operation of inputting the storage verifying request to the secure verifying unit 500.

As an example, the host can be provided as one of various elements constituting an electronic device, such as a computer, a portable computer, an UMPC (Ultra Mobile PC), a net-book, a PDA (Personal Digital Assistant), a web tablet, a wireless phone, a mobile phone, a smart phone, an e-book, a PMP (Portable Multimedia Player), a PSP (Playstation Portable), a navigation device, a black box, a digital camera, a 3-dimensional television, a digital audio recorder, a digital audio player, a digital picture recorder, a digital picture player, a digital video recorder, a digital video player, a device capable of transmitting and/or receiving information in wireless environment, one of various electronic devices constituting a home network, an RFID device, one of various elements constituting a computing system, or the like.

Referring to FIG. 9, the secure data storage authentication system 30, according to an example embodiment may include a memory device 50 including a secure logic 200, an I/O logic 300, a memory unit 100, and a controller 60 including a secure verifying unit 500. The secure data storage authentication system 30 shown in FIG. 9 may be, for example, a portable memory device, such as an SD card, an MMC card, a smart card, or a USB memory. The secure data storage authentication system 30 shown in FIG. 9 may be a solid State Drive (SSD).

The secure verifying unit 500 shown in FIG. 9 may operate in substantially the same manner as the secure verifying unit 500 shown in FIG. 7, except that the storage verifying request is received from an external device, such as a host, through the controller 60, and the verification result is output to the external device through the controller 60. However, similar to the secure verifying unit 500 shown in FIG. 8, the secure verifying unit 500 shown in FIG. 9 may receive the storage verifying request only from an authenticated application program of the external device.

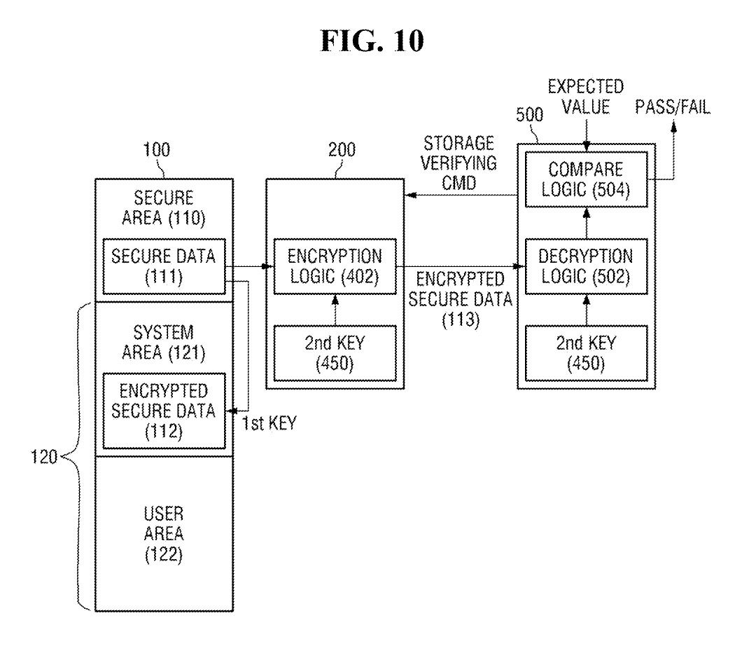

Hereinafter, the operation of the secure data storage authentication system 30 according to an example embodiment will be described in detail with reference to FIG. 10.

The secure data storage authentication system 30 according to the embodiment of the present invention includes a secure logic 200 that encrypts secure data 111 using a verifying key and outputs the encrypted secure data to the secure verifying unit 500. That is to say, the secure logic 200 converts the secure data 111 in an encrypted form and outputs the converted secure data. Here, a second key 450 used in encryption may be stored in a nonvolatile storage unit provided in the secure logic 200 or may be a hard wired key. Here, the secure verifying unit 500 may be provided in a secure data recording device or a secure data storage verifying device.

The secure logic 200 preferably encrypts the secure data 111 using a symmetric encryption algorithm to make an encryption key and a decryption key equal to each other. An encryption algorithm complying with an advanced encryption standard (AES), for example, may be used as the symmetric encryption algorithm.

As described above, the encrypted secure data 112 may be stored in the system area 121 of the memory unit 100. A first key used in encrypting secure data is different from the second key 450. Therefore, the encrypted secure data 112 stored in the system area 121 and encrypted secure data 113 provided from the secure logic 200 to the secure verifying unit 500 are different from each other. Throughout the present disclosure, the second key 450 may also be referred to as a ‘verifying key’.

The encryption may be performed by an encryption logic 402 provided in the secure logic 200.

The secure verifying unit 500 may also have the second key 450. The second key 450 may be stored in a nonvolatile storage unit provided in the secure verifying unit 500 or may be a hard wired key. In order to prevent leakage of the second key 450, the secure verifying unit 500 preferably stores the second key 450 in a storage unit that is not accessed by an external device. The second key 450 may be stored in the secure logic 200 and the secure verifying unit 500 at the time of manufacturing the secure logic 200 and the secure verifying unit 500.

A decryption logic 502 included in the secure verifying unit 500 decrypts the encrypted secure data 113 provided from the secure logic 200 using the second key 450. Thereafter, a compare logic 504 compares the decrypted secure data with an expected value. If the decrypted secure data and the expected value are equal to each other, a PASS signal is output, and if not, a FAIL signal is output.

In one example embodiment, the secure verifying unit 500 deletes the decrypted secure data immediately after the compare logic 504 determines whether the decrypted secure data and the expected value are equal to each other.

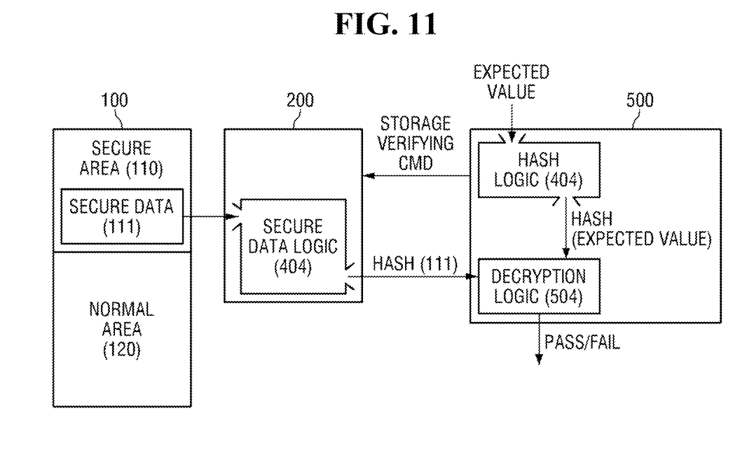

Hereinafter, the operation of the secure data storage authentication system 30 according to an example embodiment will be described in more detail with reference to FIG. 11.

The secure data storage authentication system 30 according to an example embodiment includes a secure logic 200 that inputs the secure data 111 to a predefined one-way function and outputs an output value of the one-way function to the secure verifying unit 500. That is to say, the secure logic 200 according to an example embodiment converts the secure data 111 into a function value of the one-way function and outputs the converted secure data. The one-way function is incapable of deriving an input value from an output value, like a hash function. Here, the secure verifying unit 500 may be provided in a secure data recording device or a secure data storage verifying device.

As shown in FIG. 11, the secure logic 200 may include a hash logic 404. The hash logic 404 provides a hash value of the secure data to the secure verifying unit 500.

The secure verifying unit 500 may also include the hash logic 404. The secure verifying unit 500 executes an operation of a hash value of the expected value using the hash logic 404 and determines whether the hash value of the expected value and a hash value of the secure data provided from the secure logic 200 are equal to each other using the compare logic 504. If it is determined that the hash value of the expected value and the hash value of the secure data provided from the secure logic 200 are equal to each other, a PASS signal is output, and if not, a FAIL signal is output.

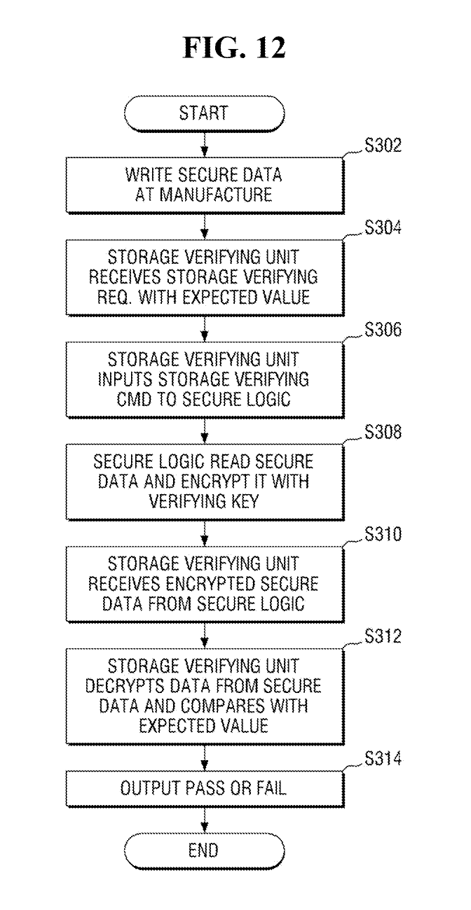

A method for verifying secure data storage according to an example embodiment will be described with reference to FIG. 12.

First, at the time of manufacturing a memory device, secure data may be stored in a secure area 110 of the memory device (S302). As described above, the secure area 110 may be accessed only by the secure logic 200 and may not be additionally programmed after it is programmed once.

Next, the secure verifying unit 500 may receive a storage verifying request. The storage verifying request may include expected values expected to have been stored in the secure area 110 in forms of parameters (S304). According to an example embodiment, even if the secure verifying unit 500 does not receive the storage verifying request, after the secure data is stored (S302), the storage verifying method may be automatically performed.

Next, the secure verifying unit 500 inputs the storage verifying command to the secure logic 200 (S306). Here, the expected values are not included in the storage verifying command.

The secure logic 200 reads the secure data 111 stored in the secure area 110 in response to the input storage verifying command, and the read secure data is encrypted using a verifying key (S308) and provided to the secure verifying unit 500 (S310).

The secure verifying unit 500 decrypts the encrypted secure data provided from the secure logic 200 and compares the decrypted secure data with the expected value input together with the storage verifying command (S312). In one example embodiment, the secure verifying unit 500 deletes the decrypted secure data immediately after the comparing. If the decrypted secure data is equal to the expected value, the secure verifying unit 500 outputs a PASS signal. If the decrypted secure data is not equal to the expected value, the secure verifying unit 500 outputs a FAIL signal (S314).

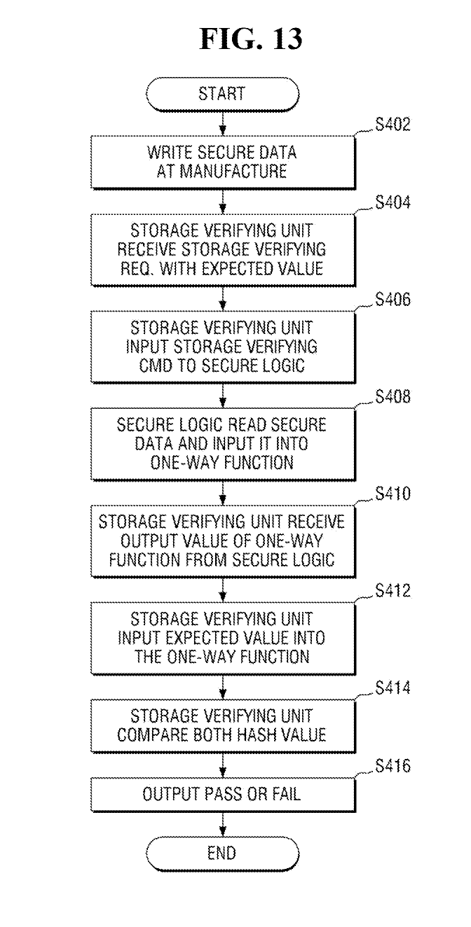

A method for verifying secure data storage, according to an example embodiment will be described with reference to FIG. 13.

In one example embodiment, at the time of manufacturing the memory device, secure data may be stored in the secure area 110 of the memory device (S402). As described above, the secure area 110 may be accessed only by the secure logic 200 and may not be additionally programmed after it is programmed once.

Next, the secure verifying unit 500 may receive a storage verifying command (S404). The storage verifying command may include expected values expected to have been stored in the secure area 110 in forms of parameters.

According to an example embodiment, even if the secure verifying unit 500 does not receive the storage verifying request, after the secure data is stored (S402), the storage verifying method may be automatically performed.

Next, the secure verifying unit 500 inputs the storage verifying command to the secure logic 200 (S406). Here, the expected values are not included in the storage verifying command.

The secure logic 200 reads the secure data 111 stored in the secure area 110 in response to the input storage verifying command, the read secure data is input to a one-way function, for example, a hash function (S408), and the secure logic 200 provides the output value of the one-way function to the secure verifying unit 500 (S410).

Like the secure logic 200, the secure verifying unit 500 inputs the expected value provided with the storage verifying command, to the one-way function, for example, the hash function, and calculate the output value of the one-way function (S412). Thereafter, the secure verifying unit 500 compares the hash function output value provided from the secure logic 200 with a hash function output value which the secure verifying unit 500 calculated (S414). If it is determined that the hash function output value which the secure verifying unit 500 calculated and the hash function output value from the secure logic 200 are equal to each other, a PASS signal is output, and if not, a FAIL signal is output (S416).

Variations of the example embodiments are not to be regarded as a departure from the spirit and scope of the example embodiments, and all such variations as would be apparent to one skilled in the art are intended to be included within the scope of this disclosure.

1. A memory device comprising:
an input/output (I/O) interface;
a secure logic configured to receive a storage verifying command including an expected value of secure data, from an external device via the I/O interface;
an I/O logic configured to
receive a request for at least one of inputting user data into the memory device and outputting user data from the memory device via the I/O interface, and
perform at least one of the inputting and the outputting based on the request; and
a memory unit including
a secure area for storing the secure data, the secure area being accessible by the secure logic, and
a normal area for storing the user data, the normal area being accessible by the I/O logic, wherein the secure logic is configured to
read the secure data from the secure area in response to the input of the storage verifying command, and
output a storage verifying result to the external device, without outputting the secure data to the external device, according to whether the secure data expected value is identical to the secure data.

2. The memory device of claim 1, wherein the secure area is a read only accessible area.

3. The memory device of claim 1, wherein the secure data is an intrinsic identifier of the memory device.

4. A system for verifying secure data storage, the system comprising:
a secure verifying unit configured to receive a verify request signal including an expected value of secure data;
an I/O interface;
a secure logic configured to respond to a storage verifying command from the secure verifying unit received via the I/O interface;
an I/O logic configured to
receive a request for at least one of the inputting user data into a memory device and outputting user data from the memory device via the I/O interface, and
perform at least one of the inputting and the outputting based on the request; and
a memory unit including
a secure area for storing the secure data, the secure area being accessible by the secure logic, and
a normal area for storing the user data, the normal area being accessible by the I/O logic, wherein the secure logic is configured to read the secure data from the secure area in response to the storage verifying command, convert the secure data, and output the converted secure data to the secure verifying unit, and
the secure verifying unit is configured to receive the converted secure data from the secure logic, determine whether the secure data expected value is equal to the secure data using the converted secure data, and output a storage verification result according to whether the secure data expected value is equal to the secure data.

5. The system of claim 4, wherein the secure logic, the I/O logic, the I/O interface and
the memory unit are provided in a memory device, and
the secure verifying unit is provided in a storage verifying system connected to the memory device via the I/O interface.

6. The system of claim 4, wherein the secure logic, the I/O logic, the I/O interface and
the memory unit are provided in a memory device, and
the secure verifying unit is provided in a controller connected to the memory device.

7. The system of claim 4, wherein the secure logic is configured to encrypt the secure data using a verifying key and output the encrypted secure data to the secure verifying unit, and
the secure verifying unit is configured to decrypt the encrypted secure data received from the secure logic using the verifying key, extract the secure data and determine whether the extracted secure data is equal to the expected value.

8. The system of claim 7, wherein the secure verifying unit deletes the extracted secure data after determining whether the extracted secure data is equal to the expected value.

9. The system of claim 7, wherein the verifying key is stored in the secure logic and the secure verifying unit.

10. The system of claim 7, wherein the normal area includes a system area that is read only accessible, a user area that is read/write accessible, and the encrypted secure data is stored in the system area.

11. The system of claim 10, wherein an encryption key used for encrypting the secure data stored in the system area is different from the verifying encryption key.

12. The system of claim 4, wherein the secure logic is configured to input the secure data to a one-way function and output an output value of the one-way function to the secure verifying unit, and
the secure verifying unit is configured to determine whether the output value of the one-way function received from the secure logic and the output value obtained by inputting the expected value to the one-way function are equal.

13. The system of claim 4, wherein the secure verifying unit deletes the output value of the one-way function received from the secure logic upon determining whether the output value of the one-way function received from the secure logic and the output value obtained by inputting the expected value to the one-way function are equal.

14.-15. (canceled)

16. A system comprising:
a memory device including,
a memory unit having at least a secure area for storing secure data, and secure logic configured to encrypt the secure data and output the encrypted secure data in response to a verification command; and
a verifying unit configured to,
send the verification command to the secure logic, and
determine whether secure data has been properly stored in the secure area based on the encrypted secure data output from the memory device.

17. The system of claim 16, wherein the verifying unit is configured to send the verification command to the secure logic upon receiving a verification request from an external device.

18. The system of claim 17, wherein the verification request includes an expected value of the secure data, and
the verifying unit is configured to determine whether the secure data has been properly stored in the secure area based on the encrypted secure data and the expected value.

19. The system of claim 18, wherein the verifying unit is configured to determine whether the secure data has been properly stored in the secure area by,
decrypting the encrypted secure data using a verifying key,
extracting the secure data, and
determining whether the extracted secure data corresponds to the expected value.

20. The system of claim 18, wherein the verifying unit is further configured to output at least one of a FAIL signal and a Pass signal based on the result of the determining.

21. The system of claim 16, wherein the secure area is only accessible by the secure logic.
